(19) United States
(12) Patent Application Publication
(10) Pub. No.: US 2004/0053104 A1
(43) Pub. Date: Mar. 18, 2004

(54) Current feeders for electrochemical cell stacks

(76) Inventors: Donald James Novkov, Encinitas, CA (US); Stuart I. Smedley, Escondido, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/660,947

(22) Filed: Sep. 12, 2003

Related U.S. Application Data
(60) Provisional application No. 60/410,562, filed on Sep. 12, 2002.
(60) Provisional application No. 60/410,558, filed on Sep. 12, 2002.

(51) Int. Cl. H01M 8/24; H01M 2/08; H01M 8/02

(52) U.S. Cl. 429/34; 429/35; 429/38; 429/210

(57) ABSTRACT

Improved electrochemical cell plates comprise a polymer layer and an electrically conductive structure that passes through the polymer layer, which provides electrical conductivity between adjacent cells in an electrochemical cell stack. Since the cell plates are composed of a polymeric layer, the cell plates can be more easily sealed to cell frame of the fuel cell stack. Additionally, the conductive structures of the cell plates provide low electrical resistance pathways for current flow between the anode of one cell and the cathode of an adjacent cell. Furthermore, in some embodiments of the present disclosure, the conductive structure can also serve to maintain the spacing between adjacent cells.

### CROSS REFERENCE TO RELATED APPLICATIONS

The current application claims the benefit of priority from U.S. provisional patent application filed on Sep. 12, 2002, entitled “Current Feeder For A Bipolar Cell Stack” having Serial No. 60/410,562, and from U.S. provisional patent application filed on Sep. 12, 2002, entitled “Method of Producing A Bipolar Plate For A Fuel Cell” having Serial No. 60/410,558, both of which are herein incorporated by reference.

### FIELD OF THE INVENTION

The invention relates to cell plate assemblies for electrochemical stacks. In particular, the invention relates to cell plate assemblies that separate adjacent cells in an electrochemical stack and also provide for electrical conductivity between the anode of one cell and the cathode of an adjacent cell. The invention further relates to methods for forming electrochemical cell stacks.

### BACKGROUND OF THE INVENTION

In general, a fuel cell is an electrochemical device that can convert chemical energy stored in fuels such as hydrogen, zinc, aluminum and the like, into useful energy. A fuel cell generally comprises a negative electrode, a positive electrode, and a separator within an appropriate container. Fuel cells operate by utilizing chemical reactions that occur at each electrode. In general, electrons are generated at the anode and flow through an external circuit to the cathode where a reduction reaction takes place. The electrochemical potential difference between the two electrodes that can be used to drive useful work in the external circuit. For example, in one embodiment of a fuel cell employing metal, such as zinc, iron, lithium and/or aluminum, as a fuel and potassium hydroxide as the electrolyte, the oxidation of the metal to form an oxide or a hydroxide takes place at the anode. In commercial embodiments, several fuel cells are usually arranged in series, or stacked, in order to create larger voltages. For commercially viable fuel cells, it is desirable to have electrodes that can function within desirable parameters for extended periods of time on the order of 1000 hours or greater.

A fuel cell is similar to a battery in that both generally have a positive electrode, a negative electrode and electrolytes. However, a fuel cell is different from a battery in the sense that the fuel in a fuel cell can be replaced without disassembling the cell to keep the cell operating. In some embodiments, a fuel cell can be coupled to, or contain, a fuel regeneration unit which can provide the fuel cell with regenerated fuels.

Fuel cells are a particularly attractive power supply because they can be efficient, environmentally safe and completely renewable. Metal/air fuel cells can be used for both stationary and mobile applications, such as all types of electric vehicles. Fuel cells offer advantages over internal combustion engines, such as zero emissions, lower maintenance costs and higher specific energies. Higher specific energies associated with selected fuels can result in weight reductions. In addition, fuel cells can give vehicle designers additional flexibility to distribute weight for optimizing vehicle dynamics.

### SUMMARY OF THE INVENTION

In a first aspect, the pertains to a cell stack comprising a first cell, a second cell and a bipolar plate, the first cell and the second cell each comprising an anode and a cathode, with the first cell and the second cell aligned such that the anode in the first cell is located adjacent to the cathode of the second cell. In these embodiments, the bipolar plate comprises a polymer layer and an electrically conductive structure passing through the polymer layer, wherein the electrically conductive structure provides electrical contact between the anode of the first cell and the cathode of the second cell

In another aspect, the invention pertains to a bipolar plate for an electrochemical cell comprising a polymer layer, an electrically conducting structure passing through the polymer layer and a sealing element. In these embodiments, the sealing element can seal the electrically conducting structure to the polymer layer and prevent fluids from passing through the polymer layer.

In a further aspect, the invention pertains to a method of making a fuel cell comprising, assembling a fuel cell stack by positioning a cell plate between an anode of a first cell and a cathode of an adjacent cell. In these embodiments, the cell plate comprises a polymer layer and an electrically conductive structure that passes through the polymer layer to provide an electrical connection between the anode of the first cell and the cathode of the adjacent cell.

### BRIEF DESCRIPTION OF THE FIGURES

FIG. 1 is a fragmentary cross-sectional view of two adjacent electrochemical cells separated by a plate with an electrically conductive structure penetrating the plate, which provides electrical conductivity between the adjacent cells.

FIG. 2 is a fragmentary cross-sectional view of two adjacent electrochemical cells separated by a plate with an electrically conductive structure penetrating the plate, which provides electrical conductivity between the adjacent cells.

FIG. 3 is a perspective view of an expanded electrically conductive screen, with a conductive sheet inserted partially into a polymer frame.

FIG. 4 is a top view of an expanded electrically conductive sheet that has been folded over and joined onto the surface of a polymer frame.

FIG. 5 is a cross-sectional view of the interface between two cells stacked together in series showing a partial cell electrically connected to an adjacent cell by way of an electrically conductive sheet that penetrates a polymer plate.

FIG. 6 is a cross-sectional view of the interface between two cells stacked together in series, wherein the cross section is taken ninety degrees relative to the cross-sectional view of FIG. 5.

FIG. 7 shows a schematic diagram of a cell stack and a fuel storage container, where fuel delivery pipes are shown in phantom lines.

### DETAILED DESCRIPTION OF THE INVENTION

Improved electrochemical cell plates comprise a polymer layer and an electrically conductive structure that passes through the polymer layer which provides electrical conductivity between adjacent cells in an electrochemical cell stack. Since the cell plates are composed of a polymeric layer, the cell plates can be more easily sealed to cell frame of the fuel cell stack. Additionally, the conductive structures of the cell plates provide a low electrical resistance pathways for current flow between the anode of one cell and the cathode of an adjacent cell. Furthermore, in some embodiments of the present disclosure, the conductive structure can also serve to maintain the spacing between adjacent cells. In one embodiment, the electrically conductive structure may be a conductive protuberance, such as, for example, a metal pin or the like, that extends through, the polymer layer, while in other embodiments the electrically conductive structure may be a conductive sheet, such as screen, foil or mesh, that extends through and/or wraps around the polymer layer.

There are several types of chemistries typically employed in electrochemical cells including, for example, hydrogen, direct methanol and metal based fuel systems. A metal based fuel cell is an electrochemical cell that uses a metal, such as zinc particles, as fuel in the anode. In a metal fuel cell, the fuel is generally stored, transported and used in the presence of a reaction medium or electrolyte, such as potassium hydroxide solution. The zinc metal is generally in the form of particles to allow for sufficient flow of the zinc fuel through the fuel cell. Specifically, in metal/air batteries and metal/air fuel cells, oxygen is reduced at the cathode, and metal is oxidized at the anode. In some embodiments, oxygen is supplied as air. For convenience, air and oxygen are used interchangeably throughout unless a specific context requires a more specific interpretation. In other embodiments, the oxidizing agent supplied to the cathode may be bromine gas or other suitable oxidizing agents. In some embodiments, the fuel compositions may further include additional additives, such as stabilizers and/or discharge enhancers.

In general, gas diffusion electrodes are suitable for catalyzing the reduction of gaseous oxidizing agents, such as oxygen, at a cathode of a metal fuel cell or battery. In some embodiments, gas diffusion electrodes comprise an active layer associated with a backing layer. The active and backing layers of a gas diffusion electrode are porous to gases such that gases can penetrate through the backing layer and into the active layer. However, the backing layer of the electrode is generally sufficiently hydrophobic to prevent diffusion of the electrolyte solution into or through the backing layer. The active layer generally comprises catalyst particles for catalyzing the reduction of a gaseous oxidizing agent, electrically conductive particles such as, for example, conductive carbon and a polymeric binder. Gas diffusion electrodes suitable for use in metal/air fuel cells are generally described in co-pending application Ser. No. 10/364,768, filed on Feb. 11, 2003, titled “Fuel Cell Electrode Assembly,” and in co-pending application Ser. No. 10/288,392, filed on Nov. 5, 2002, titled “Gas Diffusion Electrodes,” which are hereby incorporated by reference.

In metal/air fuel cells that utilize zinc as the fuel, the following reaction takes place at the anodes:

Zn+4OH⁻→Zn(OH)₄²⁻+2e³¹. (1)

The two released electrons flow through a load to the cathode where the following reaction takes place:

$$\frac{1}{2} {O}_{2} + 2 {ⅇ}^{-} + {H}_{2} O -> 2 {OH}^{-} . \qquad ( 2 )$$

The reaction product is the zincate ion, Zn(OH)₄²⁻, which is soluble in the reaction solution KOH. The overall reaction which occurs in the cell cavities is the combination of the two reactions (1) and (2). This combined reaction can be expressed as follows:

$$Zn + 2 {OH}^{-} + \frac{1}{2} {O}_{2} + {H}_{2} O -> {Zn ( OH )}_{4}^{{2}^{-}} . \qquad ( 3 )$$

Alternatively, the zincate ion, Zn(OH)₄²⁻, can be allowed to precipitate to zinc oxide, ZnO, a second reaction product, in accordance with the following reaction:

Zn(OH)₄²⁻→ZnO+H₂O+2OH⁻. (4)

In this case, the overall reaction which occurs in the cell cavities is the combination of the three reactions (1), (2), and (4). This overall reaction can be expressed as follows:

$$Zn + \frac{1}{2} {O}_{2} -> ZnO . \qquad ( 5 )$$

Under ambient conditions, the oxidation of zinc yields an open-circuit voltage potential of about 1.4V. For additional information on this embodiment of a zinc/air battery or fuel cell, the reader is referred to U.S. Pat. Nos. 5,952,117; 6,153,329; and 6,162,555, which are hereby incorporated by reference herein as though set forth in full.

As described above, a fuel cell comprises an anode, a cathode and an electrolyte within an appropriate container. However, the voltage produced by an individual fuel cell is generally small, usually on the order of about 0.7 volts. As a result, commercial embodiments of fuel cells have numerous anodes and cathodes coupled in series to produce a fuel cell stack. Individual cells have generally been coupled, or connected, to adjacent cells by bipolar plates or the like. Generally, the bipolar plates comprise an electrically conductive material, such as graphite or stainless steel, with channels defined along the face of the plates to permit reactant gas to flow to the electrodes. The electrical conductivity permits the bipolar plates to electrically connect the anode of one cell with a cathode of an adjacent cell.

The use of bipolar plates in fuel cell stacks can create several manufacturing issues including, for example, increased expense and difficulty in sealing the plates to the cell frame. As noted above, conventional bipolar plates are made of conductive materials such as graphite or stainless steel, which can increase the cost of producing the bipolar plates as compared to other materials like, for example, plastics. Additionally, conventional bipolar plates have to be sealed to the cell frame to prevent electrolyte and/or reactant gas from escaping out of the cell. As described herein, a polymeric cell plate having a current collecting structure can provide electrical conductivity between an adjacent anode and a cathode within a cell stack.

As an alternative to placement of an electrically conductive bi-polar plate, as described herein a polymer plate is placed between adjacent cells and one or more electrically conductive structures are placed to conduct current from one side of the polymer plate to the other side of the polymer plate to connect the adjacent cells in series. The polymer plate or layer together with the one or more electrically conductive structures form a bipolar plate for connecting adjacent cells in series. In general, the electrically conductive structure can penetrate through the polymer plate and/or wrap around the electrically conductive plate, although it may be easier to seal the interface between the two cells if the electrically conductive structure penetrates the polymer plate. The polymer plate provides for simplified sealing of the polymer plate to the fuel cell case to prevent flow of electrolyte of the anode to flow into the air plenum that supplies gaseous oxidizing agent to the adjacent cathode. In some embodiments, the electrically conductive structure can be more a more localized shape that projects through the polymer plate and may also span the anode bed to provide electrical conductivity from the anode to the adjacent cathode. In other embodiments, the electrically conductive structure can be a an extended electrically conductive structure, such as a sheet, foil or grid, that can similarly penetrate the polymer plate to provide an electrical conduction pathway from one side of the polymer plate to other. A plurality of similar or different types of electrically conductive structures can be used together.

In one embodiment, a cell plate comprises a polymer layer and at least one conductive protuberance that passes though the polymer layer. The conductive protuberance functions to electrically connect the anode of one electrochemical cell with the cathode of an adjacent cell. In some embodiments, a plurality of conductive protuberances may pass though a cell plate. Additionally, a current collector may be associated with the cell plate and conductive protuberance to facilitate the transfer of electrical current between adjacent cells. In one embodiment, the conductive protuberance may be a pin. Generally, the conductive protuberance may be composed of any conductive material that is chemically inert with respect to the reactants and/or electrolyte present in the electrochemical cell. Suitable materials include, for example, graphite, metals, metal alloys, conductive polymers and combinations thereof.

In another embodiment, a cell plate comprises a polymer layer and a conductive sheet though the polymer layer. In these embodiments, the conductive sheet can be inserted though an opening in the polymer layer and aligned along the face of one side of cell plate. Additionally, the conductive sheet can be connected to a cathode structure though the opening in the cell plate. Generally, the cathode structure can be aligned along the opposite face of the cell plate, adjacent to an air plenum adapted to supply the cathode with an oxidizing agent, such as air. Electrons generated in one electrochemical cell can be conducted by the conductive sheet to cathode of an adjacent cell.

Cell Plates

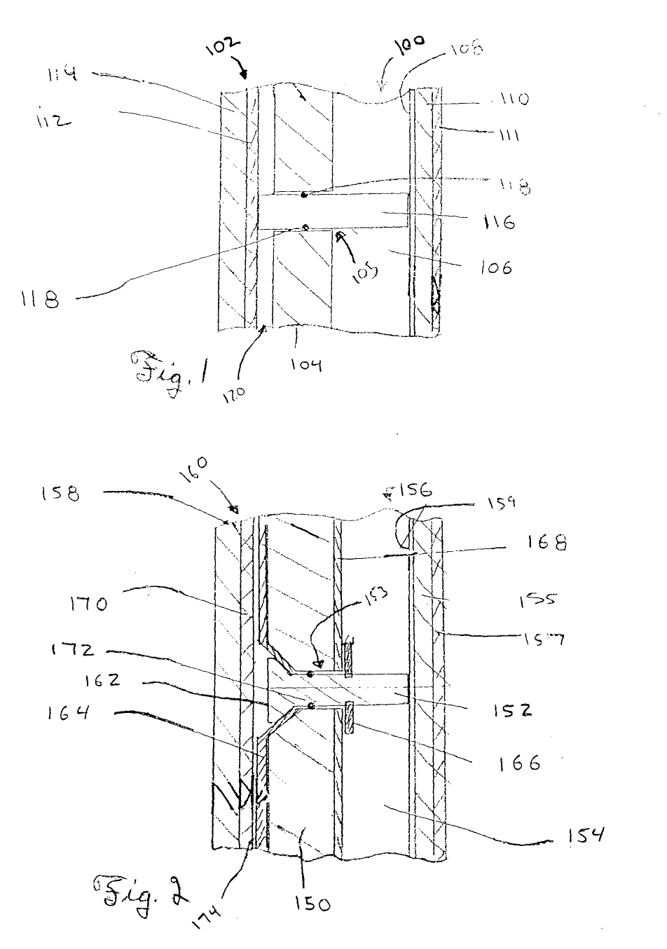

As noted above, the electrically conductive structure connecting the cathode and anode can be a localized structure that penetrates through the polymer plate or layer. In some embodiments, the localized structure can be an electrically conductive protuberance such as shown in FIG. 1. FIG. 1 shows a first electrochemical cell 100 and a partial second electrochemical cell 102 separated by a cell plate 104. First cell 100 comprises anode bed 106, separator 108, cathode 110 and cathode current collector 111. As shown in FIG. 1, partial second cell 102 comprises cathode current collector 112 and cathode 114. Electrically conducting protuberance 116 passes through cell plate 104 via opening 105 and contacts cathode current collector 112 of second cell 102. Electrically conducting protuberance 116 also passes through anode bed 106 of first cell 100. Electrons generated in the anode-half reaction in first cell 100 can be conducted through conductive protuberance 116 to cathode current collector 112, where the electrons can be made available to cathode 114 of second cell 102. In some embodiments, conducting protuberance 116 further comprises sealing elements 118, which seals conductive protuberance 116 to cell plate 104 and prevents electrolyte and/or reactant flow between first cell 100 and second cell 102. Although FIG. 1 shows a single conducting protuberance 116 passing through polymeric cell plate 104, some embodiments comprise a plurality of conducting structures passing through plate 104 to form an electrical connection between cathode current collector 112 and anode bed 106. For example, 16 connecting structures can be used for a 550 cm² electrode area. A suitable range of numbers of conducting structures can be from 1 to 4 for every about 50 cm² of electrode area. One of ordinary skill in the art will recognize that no particular number of conducting structures is required by the present disclosure, and the number and spacing of the conducting structures can be selected based on the design of a particular electrochemical cell stack.

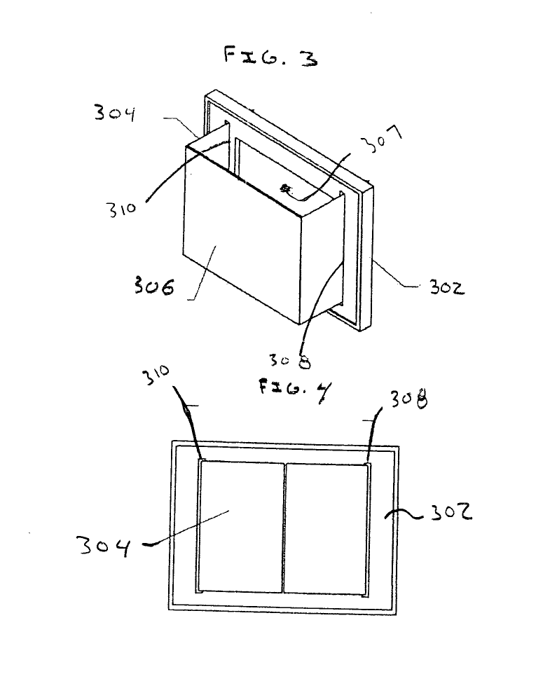

FIG. 2 shows another embodiment of a cell plate 150 with an electrically conductive protuberance 152 electrically coupling anode bed 154 of first cell 156 to adjacent cathode 158 of partial second cell 160. As shown in FIG. 2, first cell 156 comprises cathode 155, cathode current collector 157, separator 159 and anode bed 154. In some embodiments, first cell 156 can further comprise anode bed current collector 168, which can facilitate the flow of electrical current from anode bed 154 to conductive protuberance 152. As shown in FIG. 2, partial second cell 160 comprises cathode current collector 170, cathode 158, cell plate current collector 164 and flow channel 174. Additionally, in some embodiments, electrically conductive protuberance 152 passes through cell plate 150 via opening 153.

Referring to FIG. 2, in this embodiment, electrically conducting protuberance 152 can have a head portion 162, which can hold cell plate current collector 164 against the surface of cell plate 150. Similarly, in some embodiments, conductive structure 152 can comprise nut 166, which can holds anode bed current collector 168 in a desired position. Additionally or alternatively, current collectors 168, 164 may be held against the surface of the cell plate by suitable adhesives or mechanical fasteners such as, for example, clips or brackets. In this embodiment, electrical current can conduct from anode bed 154 into anode bed current collector 168, through electrically conductive protuberance 152 and into cell plate current collector 164. In some embodiments, the current collectors 164, 168 can be a metal mesh or foil, while in other embodiments the current collectors may comprise a metal alloy or a conductive polymer. Suitable metals include, for example, nickel, aluminum and copper.

In some embodiments, anode bed current collector 168 directly contacts anode bed 154 and also contacts conductive protuberance 152, which allows electrons generated in the anode bed to be collected by current collector 168 and conducted to conductive protuberance 152. As noted above, conductive protuberance 152 passes through cell plate 150 via opening 153 and directly contacts cell plate current collector 164, such that current can conduct from conductive protuberance 152 into current collector 164. Generally, cell plate current collector 164 contacts cathode current collector 170, such that current can conduct from current collector 164 into cathode current collector 170, and ultimately to cathode 158 where electrons can be involved in a cathode half-reaction. In some embodiments, the cathode side of cell plate 150 can have raised areas, such as diamond shaped protuberances, that extend the current collector 164 away from the surface. If current collector is an expanded metal, metal mesh or the like, cell plate current collector is porous to gas flow. When assembled within the completed stack, the cell plate current collector 158 and the cathode current collector, such as an expanded metal along the back side of the cathode, can touch to provide the electrical contact between the two current collectors. If they are formed from gas permeable materials, such as expanded metal, a mesh or the like, gas can reach the cathode.

Referring to FIGS. 1 and 2, sealing members 118, 172 function to seal the conductive protuberances to the cell plate, which prevents the flow of electrolyte and/or reactants between adjacent cells. In one embodiment, sealing members 118, 172 can be o-rings or the like, although other sealing structures can also be used. In some embodiments, flow channel 120, 174 is provided between the cell plate and cathode current collector, which provides a flow pathway for an oxidizing agent such as, for example, oxygen gas. In embodiments where flow channel 120, 174 is used as a flow pathway for oxygen, the cathode current collector should be a porous structure that permits the oxidizing gas to diffuse through the current collector to the active layer of the associated cathode.

As previously described, the conductive protuberance can be composed of any electrically conductive material suitable for use in electrochemical cell applications. Suitable materials include, for example, metals such as copper, iron, nickel, aluminum, conductive polymers, metal alloys and combinations thereof. The conductive protuberance can be any reasonable shape. In some embodiments, the conductive protuberance can be a pin or a rod having a circular cross section, while in other embodiments, the conductive structure may be a pin with a oval cross section, a rectangular cross-section or the like. In some embodiments, the pin or rod can have an elongated major axis relative to a minor axis. The size and shape of the cross section can be selected based on structural considerations, as well as the maintenance of suitable flow through the anode bed. One of ordinary skill in the art will recognize that additional conductive protuberance shapes and cross sections are contemplated and are within the present disclosure.

Additionally, the conductive protuberance can also serve to establish and/or maintain the spacing between adjacent cells by setting the distance between the anode of one cell and the cathode of an adjacent cell. The length of the conductive protuberance is generally determined by the thickness of the cell plate and the width of the anode bed in a particular fuel cell design. In some embodiments of a metal-air fuel cell, the conductive protuberance can have a length from about 3 mm to about 10 mm, while in other embodiments the length of the conductive protuberance can be from about 5 mm to about 8 mm. Also, in some suitable embodiments, the diameter across the cross section of the conductive protuberance can be from about 0.1 mm to about 8 mm, in further embodiments from about 0.5 mm to about 5 mm. For appropriate embodiments, the head can have a diameter, for example, of about 5 mm. One of ordinary skill in the art will recognize that additional ranges of lengths and diameters of the conductive protuberance are contemplated and are within the scope of the present disclosure.

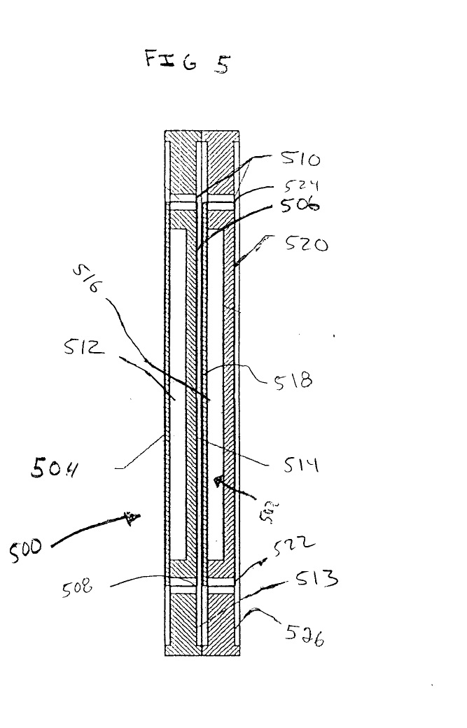

In additional or alternative embodiments, the electrically conductive structure can comprise an extended structure such as a sheet or grid that penetrates the polymer plate. FIG. 3 shows a partially assembled embodiment of an apparatus that can electrically connect adjacent cells in an electrochemical cell stack comprising cell plate 302, electrically conductive grid 304 and cathode 306. Referring to FIGS. 3 and 4, cell plate 302 further comprises openings 308, 310 located on opposite sides of cell plate 302, which permit conductive grid 304 to be inserted through cell plate 302. Once inserted through cell plate 302, conductive grid 304 can be folded down, as shown in FIG. 4, such that conductive grid 304 contacts the surface of one side of cell plate 302. In one embodiment, conductive grid 304 can be joined to the surface of cell plate 302 by, for example, heat-staking, in which the conductive grid is heated, such as with a soldering iron, to melt some polymer at the surface and fuse the conductive grid to the surface. Additionally, once conductive grid 304 is inserted through openings 308, 310, cathode 306 can be aligned along the surface of the opposite side of cell plate 302, adjacent to an air plenum 307 that provides oxygen to cathode 306.

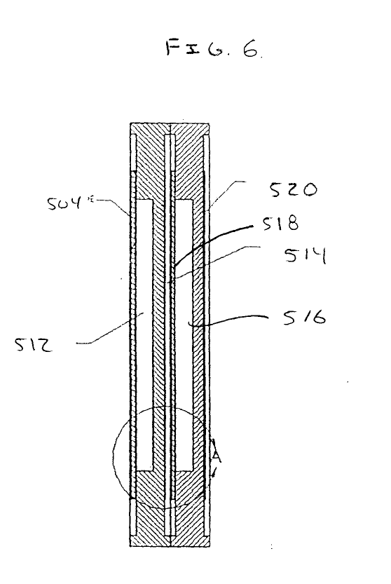

FIGS. 5 and 6 show cross-sectional views of the interface between two adjacent cells electrically connected by the cell plate structure shown partially assembled in FIGS. 3 and 4. Specifically, FIG. 5 and 6 show cross-sectional views of the interface between partial first cell 500 and an adjacent second cell 502. As shown in FIGS. 5 and 6, partial first cell 500 comprises cathode 504, conductive grid 506, openings 508, 510, air plenum 512 and cell plate 513. Second cell 502 comprises anode bed 514, air plenum 516, cathode 518, conductive grid 520, openings 522, 524 and cell plate 526. Additionally, a separator (not shown) is located between anode bed 514 and cathode 518 to electrically separate the anode and cathode of second cell 502. In some embodiments, a surface of conductive grid 506 contacts anode bed 514 of second cell 502 and also contacts cathode 504 of first cell 500 through openings 508, 510 in cell plate 513. Thus, electrons generated in anode bed 514 of second cell 502 can be collected by conductive grid 506 and conducted through cell plate 513 to cathode 504 of adjacent cell 500. In some embodiments, cathodes 504, 518 can be positioned adjacent to air plenums 512, 516, respectively. During operation of the electrochemical cell stack, air can flow through the air plenums, between the cell plates and the cathode, which provides a gaseous oxidizing agent such as, oxygen or bromine, for the cathode reactions in the individual fuel cells.

The conductive sheet 520 can by composed of any conductive material suitable for use in electrochemical cell applications including, for example, metals, metal alloys, conductive polymers, graphite and combinations thereof. Suitable metals include nickel, cooper, aluminum and iron. In some embodiments, the sheet may be an electrically conductive foil or the like, while in other embodiments the sheet may be an electrically conductive grid. The term grid is being used in its broad sense to include porous and partially porous structures including, for example, mesh structures and the like. In some embodiments, the conductive grid may comprise a structure similar to a current collector. Suitable current collectors are described below.

During operation of the cell stack, the electrically conductive sheet can collect electrons liberated in the anode reaction and conduct current through the openings in cell plate to the cathode of an adjacent cell. In some embodiments, the openings can be sealed using, for example, a thermoplastic or thermoset polymeric material to prevent electrolyte and/or reactant leakage between adjacent cells though the cell plate. Suitable sealing compositions include standard epoxys, hot-melt thermoplastic adhesives, injected thermoplastics and the like and combinations thereof.

In some embodiments, one of the electrical conductivity structures shown in FIGS. 1 and 2 can be combined with the structure shown in FIGS. 3-6 to produce a hybrid cell plate structure. For example, in one embodiment, an electrochemical cell stack can comprise a cell plate with a conductive protuberance penetrating through the cell plate and a conductive grid that penetrates though openings in the cell plate, which provides multiple conductivity pathways between adjacent cells in an electrochemical fuel cell stack. Alternatively, some adjacent cells in an electrochemical cell stack can be electrically coupled by a cell plate comprising a protuberance that penetrate through the cell plate, while other adjacent cells in the same stack may be electrically coupled by a cell plate comprising a conductive grid that penetrates though the cell plate.

A completed fuel cell generally has the electrochemical cell stack within an appropriate container, which may comprise a unitary structure or a plurality of components. The container can have inlets formed in the body of the container for supplying the electrochemical cells and/or manifolds within attached to the cells with fuel and oxidizing gas, and may also comprise outlets suitable for removing reaction products from the cells. Additionally, the container can have a negative terminal towards one end in electrical contact with the electrochemical cell stack. Similarly, the fuel cell generally has a positive terminal in contact with the electrochemical cell stack. The positive and negative terminals provide connections for forming an external circuit.

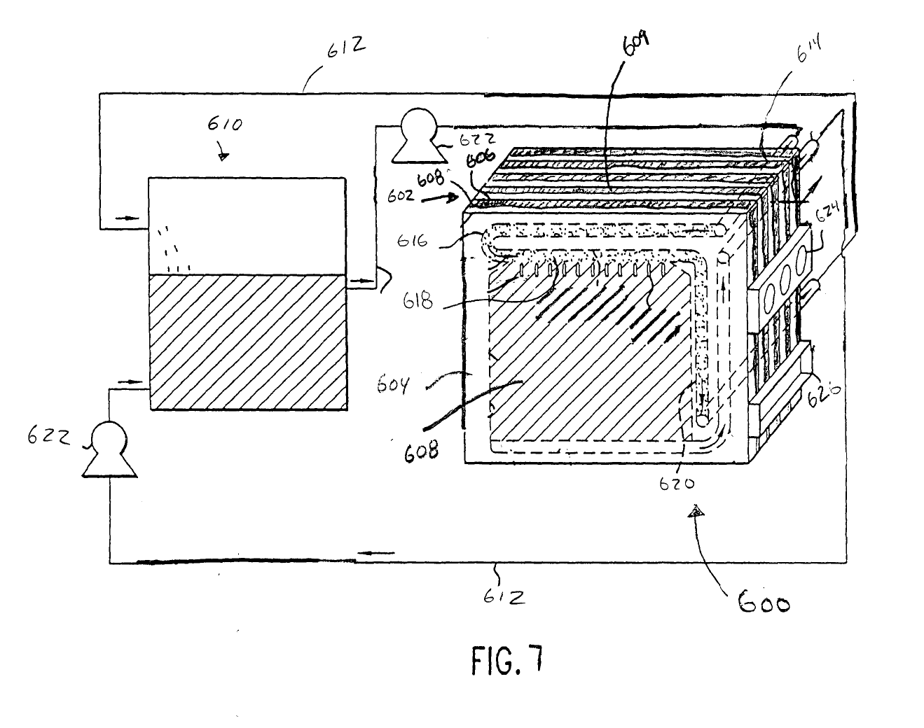

Referring to FIG. 7, an electrochemical stack 600 is shown comprising a plurality of electrochemical cells 602, wherein each cell generally can be coupled to an adjacent cell in series by at least one of the conductive structures described above. Generally each cell 602 interfaces with a fuel cell frame or body 604. Each cell 602 comprises an positive gas diffusion electrode or cathode 606 that occupies an entire surface or side of cell 602 and a anode bed 608 that occupies the an opposite entire side of cell 602. As shown in FIG. 7, the anode bed of one cell is separated from the cathode of an adjacent cell by cell plate 609, such as the cell plates described above. Additionally, the cathode and the anode of each individual cell are separated by an electrically insulating separator.

Fuel and electrolyte can be fed from fuel tank 610 through piping system 612 an into inlet manifold 614 of cell stack 600. Piping system 612 can comprise one or more fluid connecting devices, e.g., tubes, conduits, elbows, and the like, for connecting the components of system. The interface between cathode 606 and piping system 612 through inlet manifold 614 is shown in phantom lines in FIG. 7. Inlet manifold can run through cells 602, for example, perpendicular to the planes defined by the cells. Inlet manifold 614 can distribute fuel, such as fluidized zinc pellets, to the anode beds of the cells 602 via cell filling tubes 616. Electrons generated in the chemical reactions occurring in anode beds can be conducted through the cell plates 609 to the cathodes of adjacent cells.

The fuel and electrolyte flow through a flow path 618 in each cell 602. The method of delivering fuel to the cell 602 is a flow through method. For example, a dilute stream of fuel pellets in an electrolyte can be delivered to flow path 618 at the top of cell 602 via filling tubes 616. The stream can flow through path 618, across anode bed 608, and exit on the opposite side of cell 602 via outlet tube 620. In some embodiments, pumps 622 can be used to control the flow rate of electrolyte and fuel through the system.

Additionally, a supply of oxygen is required for the electrochemical reaction in each cell 602. To effectuate the flow of oxygen, one embodiment of stack 600 can include a plurality of blowers 624 and an air outlet 626 on the side of cell stack 600 to supply a flow of air comprising oxygen to the positive air electrodes/cathodes of each cell 602. In one embodiment, the plurality of blowers supplies air to the flow channels and air plenums of the cell plates described above, which provides air to the cathodes located adjacent to the flow channels and air plenums. In other embodiments, an oxidant other than air, such as pure oxygen, bromine or hydrogen peroxide, can be supplied to a cell 602 for the electrochemical reactions.

The cell plates of the present disclosure operate to separate adjacent cells in an electrochemical cell stack. In general, the cell plates can be composed of any polymeric material suitable for use in electrochemical cell applications that can prevent leakage or passage of electrolyte and/or reactants between adjacent cells and is chemically inert with respect to the reactants and electrolyte. The polymer can be a homopolymer, copolymer, block copolymer or a blend or copolymer thereof. Suitable polymers include, for example, polyethylene, poly(tetrafluoroethylene), poly(propylene), poly(vinylidene fluoride), poly(vinyl chloride), polyurethane and blends and copolymers thereof. Other suitable polymers include styrene block copolymers including, for example, styrene-isoprene-styrene, styrene-ethylene-butylene-styrene and styrene-butadiene-styrene. Suitable styrene block copolymers are sold under the trade name KRATON®.

In some embodiments, the shape of the cell plate is a rectangular sheet with a thickness generally less than the linear dimensions defining the extent of the planer surface of the cell plate. In some embodiments, the cell plate has an average thickness in the range of 0.5 mm to about 6 mm, in additional embodiments from about 0.75 mm to about 5 mm, and in further embodiments from about 1 mm to about 3 mm. A person of ordinary skill in the art will recognize that additional ranges of cell plate thickness within these explicit ranges are contemplated and are within the present disclosure.

The cathodes can be any electrode structure suitable for use in electrochemical cell applications. In some embodiments, cathodes can be gas diffusion electrodes comprising an active layer, a backing layer and an electrolyte. As described above, the backing layer of gas diffusion electrodes are sufficiently porous to allow reactant gas to penetrate to the active layer. However, the backing layer is also hydrophobic to prevent migration of the electrolyte across or into the backing layer. The active layer of the gas diffusion electrons generally comprises catalyst particles suitable for catalyzing the cathode half-reaction, electrically conductive particles, such as, for example, carbon black, and a porous polymeric binder. In some embodiments, the porous polymeric binder comprises poly(tetrafluoroethylene). For further information on gas diffusion electrode composition the reader is referred to co-pending application Ser. No. 10/364,768, filed on Feb. 11, 2003, titled “Fuel Cell Electrode Assembly,” and co-pending application Ser. No. 10/288,392, filed on Nov. 5, 2002, titled “Gas Diffusion Electrodes,” which are hereby incorporated by reference. In some embodiments, the anode bed comprises an aqueous electrolyte, such as KOH, and zinc particles. In these embodiments, the zinc particles can be oxidized to zincate ions and/or zinc oxide, which generates electrons that can flow to an adjacent cathode. In other embodiments, the anode bed may contain metals such as, for example, aluminum, lithium, magnesium, iron, sodium, or combinations thereof, in an appropriate electrolyte.

In general, the electrically conductive elements, such as current collectors, conductive sheets and conductive protuberance, described above in FIGS. 1-6 are highly electrically conductive structures that are combined with the an electrode to reduce the overall electrical resistance of the electrode assembly. Suitable current collectors can be formed from elemental metal or alloys thereof, although they can, in principle be formed from other materials. While in some embodiments a metal foil or the like can be used as a current collector, for gas diffusion electrodes, it is generally desirable to have a current collector that is permeable to the gaseous reactants such that the gas can flow through the cell. Thus, in some embodiments, the current collector comprises a metal mesh, screen, wool or the like. Suitable metals for forming current collectors that balance cost and convenience include, for example, nickel, aluminum and copper, although many other materials, metals and alloys can be used, as noted above. The current collector generally extends over a majority of the face of the electrode composition and may comprise a portion that extends beyond the electrode composition, for example, a tab that can be used to make an electrical connection to the current collector.

Forming an Electrochemical Cell Stack

The formation of an electrochemical cell stack involves combining the components of an electrode composition, forming the desired electrode structures and combining the components to form an electrode assembly. Additionally, the electrode assemblies can be combined, along with an appropriate separator, to form individual electrochemical cells, which can be further combined with a plurality of cell plates to form a electrochemical cell stack. In general, an electrode assembly comprises an active layer, a backing layer and optionally a current collector. The composition, formation and processing of electrode assemblies is generally described in, for example, co-pending application Ser. No. 10/364,768, filed on Feb. 11, 2003, entitled “Fuel Cell Electrode Assembly,” which is hereby incorporated by reference. As described above, an individual electrochemical cell comprises an anode, a cathode, an electrolyte and a separator between the anode and the cathode.

The formation of a cell plate suitable for electrically connecting adjacent cells in an electrochemical cell stack involves forming a polymeric cell plate with a desired thickness and inserting a conductive structure, such as a protuberance or grid, through the polymeric cell plate. In general, the polymeric cell plate can be formed by, for example, any known polymer processing technique such as, for example, extrusion, injection molding or compression molding. In some embodiments, openings can be formed in the cell plate during processing of the cell plate and the conductive structure can be inserted into the preformed opening, such as drill openings. In other embodiments, the conductive structures can be inserted into the polymeric cell plate during processing of the cell plate to form a completed cell plate structure in a single process. In general, the edges of a cell plate can include a groove or other appropriate structure for forming a seal between plates within the assembled cell stack. Similarly, the plate can be formed to provide for the delivery of fuel/electrolyte to the anode bed and a selected oxidizing agent to the cathode.

The formation of an electrochemical cell stack includes combining cathodes and anodes to form individual cells. The individual cells can be combined with cell plates, such as the cell plates, described above to form a cell stack, such that each cell is separated from the adjacent cell by a cell plate. In some embodiments, the cell stack can be placed into an appropriate container and sealed to form a completed electrochemical cell stack.

In other embodiments of particular interest, the cell stack is assembled by sealing adjacent plates together. For example, an o-ring or other appropriate molded compression seal can be placed near the edge between adjacent cell plates. In some embodiments, one or both sides of the cell plate have a groove to accommodate the compression seal at a particular position. A ring of bolts can be fastened along the edges of the cell plates to hold the plates together in a sealed relationship. The end plates can have conductive protrusions or other conductive elements that extend through the plate for providing conductive connection to the cell stack. In some embodiments, a copper plate with an electrically insulating outer surface and a terminal electrically connected to the copper plate and extending from the insulating surface can be placed against a terminal cell plate. The two terminals on the respective sides of the cell stack provide for the electrical connection of the cell stack to external circuits. Other cell stack structures can be assembled from the disclosure herein.

The embodiments above are intended to illustrative and not limiting. Additional embodiments are within the claims. Although the present invention has been described with reference to particular embodiments, workers skilled in the art will recognize that changes may be made in form and detail without departing from the spirit and scope of the invention.

We claim:

1. A cell stack comprising:
a first cell, a second cell and a bipolar plate, the first cell and the second cell each comprising an anode and a cathode, with the first cell and the second cell aligned such that the anode of the first cell is located adjacent to the cathode of the second cell,
wherein the bipolar plate comprises a polymer layer and a first electrically conductive structure passing through the polymer layer, wherein the electrically conductive structure provides electrical contact between the anode of the first cell and the cathode of the second cell.

2. The electrochemical cell of claim 1 wherein the first electrically conductive structure comprises a protuberance that passes through the polymer layer.

3. The electrochemical cell of claim 2 wherein the protuberance comprises a rod having an elongated major axis relative to a minor axis.

4. The electrochemical cell of claim 3 wherein the rod further comprises a head portion located on at least one end of the rod.

5. The electrochemical cell of claim 4 further comprising a current collector held against at least one surface of the polymer layer by the head portion.

6. The electrochemical cell of claim 3 wherein the rod further comprises a nut on the rod within the anode of the first cell.

7. The electrochemical cell of claim 6 further comprising a current collector held against at least one surface of the polymer layer by the nut.

8. The electrochemical cell of claim 2 further comprising sealing elements that seal the protuberance to the polymer layer to prevent fluid leakage through the polymer layer.

9. The electrochemical cell of claim 8 wherein the sealing elements comprise o-rings.

10. The electrochemical cell of claim 1 wherein the first electrically conducting structure comprises a conductive sheet that passes though the polymer layer.

11. The electrochemical cell of claim 10 wherein the conductive sheet comprises a conductive foil.

12. The electrochemical cell of claim 10 wherein the conductive sheet comprises a conductive grid.

13. The electrochemical cell of claim 10 wherein the conductive sheet is aligned along the surface of at least one side of the polymer layer.

14. The electrochemical cell of claim 10 wherein the polymer layer further comprises an air plenum on one side of the polymer layer for supplying air to the cathode.

15. The electrochemical cell of claim 14 wherein the air plenum comprises an opening along the surface of one side of the polymer layer.

16. The electrochemical cell of claim 14 wherein the cathode is aligned adjacent to the air plenum.

17. The electrochemical cell of claim 10 wherein the conductive sheet is sealed to the polymer layer by a thermoplastic polymeric material to prevent fluid flow though the polymer layer.

18. The electrochemical cell of claim 1 wherein the polymer layer comprises a polymer selected from the group consisting of polyethylene, poly(tetraflurorethylene), poly(propylene), poly(vinylidene fluoride), poly(vinyl chloride), polyurethane, and blends and copolymers thereof.

19. The electrochemical cell of claim 1 wherein the conductive structure comprises a metal, a metal alloy, a conductive polymer or a combination thereof.

20. The electrochemical cell of claim 1 wherein the bipolar plate comprises a second electrically conductive structure passing though the polymer layer.

21. The electrochemical cell of claim 20 wherein the first electrically conductive structure and the second electrically conductive structure comprise conductive protuberances.

22. The electrochemical cell of claim 20 wherein the first electrically conductive structure and the second electrically conductive structure comprise conductive sheets.

23. The electrochemical cell of claim 20 wherein the first electrically conductive structure comprises a conductive protuberance and the second electrically conductive structure comprises a conductive sheet.

24. The electrochemical cell of claim 1 wherein the conductive structure maintains the spacing between the anode and the adjacent cathode.

25. A bipolar plate for an electrochemical cell comprising:
a polymer layer;
an electrically conducting structure passing through the polymer layer; and
a sealing element which seals the electrically conducting structure to the polymer layer and prevent fluids from passing though the polymer layer.

26. The bipolar plate of claim 25 wherein the electrically conducting structure comprises a rod having an elongated major axis relative to a minor axis.

27. The bipolar plate of claim 25 wherein the electrically conducting structure comprises a conductive sheet inserted through an opening in the polymer layer.

28. The bipolar plate of claim 27 wherein the conductive sheet comprises a conductive foil.

29. The bipolar plate of claim 27 wherein the conductive sheet comprises a conductive grid.

30. The bipolar plate of claim 27 wherein the polymer layer further comprises an air plenum for supplying air to one side of the bipolar plate.

31. A method of making a fuel cell comprising:
assembling a fuel cell stack by positioning a cell plate between an anode of a first cell and a cathode of an adjacent cell, wherein the cell plate comprises a polymer layer and an electrically conductive structure that passes through the polymer layer to provide an electrical connection between the anode of the first cell and the cathode of the adjacent cell.

32. The method of claim 31 further comprising sealing adjacent cell plates to form the fuel cell stack.

33. The method of claim 31 wherein the electrically conductive structure comprises a protuberance having an elongated major axis relative to a minor axis.

34. The method of claim 31 further comprising establishing the distance between the anode of one cell and the cathode of an adjacent cell by selecting the length of the protuberance.

35. The method of claim 31 wherein the electrically conductive structure comprises a conductive sheet.
